(19) United States
(12) Patent Application Publication
(10) Pub. No.: US 2008/0112614 A1
(43) Pub. Date: May 15, 2008

(54) HISTOGRAM TILE MAP FOR GPU BASED HISTOGRAM COMPUTATION

(75) Inventors: Oliver Fluck, Plainsboro, NJ (US); Shmuel Aharon, West Windsor, NJ (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Corporate Research, Inc., Priceton, NJ (US)

(21) Appl. No.: 11/758,806

(22) Filed: Jun. 6, 2007

Related U.S. Application Data
(60) Provisional application No. 60/858,879, filed on Nov. 14, 2006.

(51) Int. Cl. G06K 9/00

(52) U.S. Cl. 382/168

(57) ABSTRACT

A method for identifying a region of interest within an image includes receiving an image. The image is divided into a plurality of tiles. It is determined which of the plurality of tiles includes the region of interest. A graphics processing unit (GPU) calculates a pixel intensity histogram for tiles that have been determined to include the region of interest. The region of interest is identified based on the calculated pixel intensity histograms.

### CROSS-REFERENCE TO RELATED APPLICATION

This application claims priority from: “Histogram Tile Maps for GPU Based Histogram Computation”, U.S. Provisional Application No. 60/858,879 of Aharon, et al., filed Nov. 14, 2006, the contents of which are herein incorporated by reference.

### BACKGROUND OF THE INVENTION

1. Technical Field

The present disclosure relates to histogram computation and, more specifically, to a histogram tile map for GPU based histogram computation.

2. Discussion of the Related Art

While the central processing unit (CPU) is a general purpose microprocessor capable of processing a wide range of instructions, a graphics processor unit (GPU) is a dedicated microprocessor for the computation of graphic-related operations. Modern GPUs have a highly parallel structure that may be exploited to perform specialized calculations substantially more efficiently than a CPU.

In the field of computerized image processing and recognition, segmentation refers to a process for locating boundaries such as lines an curves within an image. Accordingly, image segmentation may be used to locate tumors and other pathologies within a medical image. For example, image segmentation may be performed on digital medical images such as MRIs, CT scans, ultrasonic scans, PET scans, and the like, to identify internal structures of interest.

The result of image segmentation is to locate where there is a significant change in characteristics between proximate regions. These changes may represent a boundary, for example, a boundary of an organ or a tumor. Accordingly, regions of interest may be identified from the digital image.

Pixel intensity distribution histograms may be used in image segmentation. While the computation of these histograms may be performed by the CPU, such computations have proven difficult to implement on a GPU due to their highly parallel architecture.

### SUMMARY

A method for identifying a region of interest within an image includes receiving an image. The image is divided into a plurality of tiles. It is determined which of the plurality of tiles includes the region of interest. A graphics processing unit (GPU) calculates a pixel intensity histogram tiles that have been determined to include the region of interest. The region of interest is identified based on the calculated pixel intensity histograms. The region of interest may also be identified based on an initial segmentation provided by a user and/or intermediate segmentation results.

A system for identifying a region of interest within an image includes a graphical processing unit (GPU) for storing the image in texture memory. An image subdividing unit divides the image into a plurality of tiles of the same size. A tile map indicates which of the plurality of tiles are excluded from calculation. A tile histogram calculating unit calculates tile histograms for each of the plurality of tiles that are not excluded from calculation.

A computer system includes a processor and a program storage device readable by the computer system, embodying a program of instructions executable by the processor to perform method steps for calculating a global pixel intensity histogram. The method includes dividing an image into a plurality of tiles. A tile map is generated for indicating which of the plurality of tiles are excluded from calculation. A graphics processing unit (GPU) calculates a tile histogram for each of the plurality of tiles not excluded from calculation. A global pixel intensity histogram is calculated based on the calculated tile histograms.

### BRIEF DESCRIPTION OF THE DRAWINGS

A more complete appreciation of the present disclosure will be readily obtained as the same becomes better understood by reference to the following detailed description when considered in connection with the accompanying drawings, wherein:

FIG. 1 illustrates image subdivision according to an exemplary embodiment of the present invention;

FIG. 2 illustrates an example tile and a corresponding example tile histogram according to an exemplary embodiment of the present invention;

FIG. 3 illustrates an example of included and excluded tiles in a subdivided image domain according to an exemplary embodiment of the present invention;

FIG. 4 is a flow chart illustrating a method for identifying a region of interest within an image; and

FIG. 5 shows an example of a computer system capable of implementing the method and apparatus according to exemplary embodiments of the present disclosure.

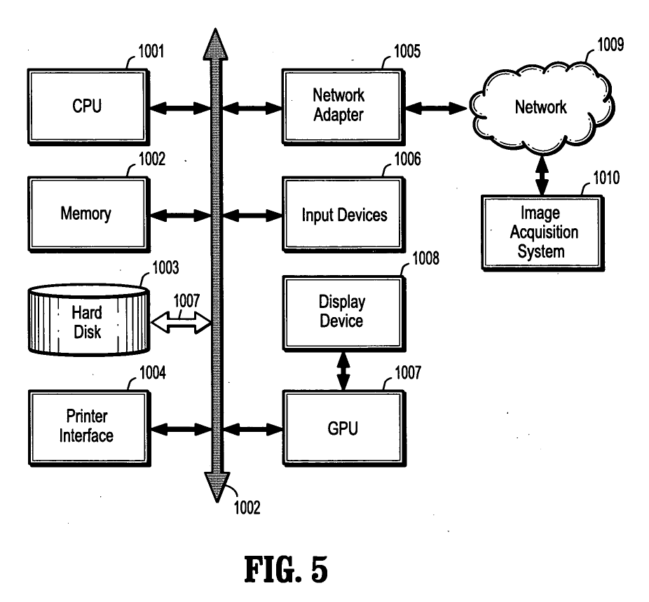

### DETAILED DESCRIPTION OF THE DRAWINGS

In describing the exemplary embodiments of the present disclosure illustrated in the drawings, specific terminology is employed for sake of clarity. However, the present disclosure is not intended to be limited to the specific terminology so selected, and it is to be understood that each specific element includes all technical equivalents which operate in a similar manner.

Exemplary embodiments of the present invention may be used to calculate pixel intensity distribution histograms using fragment shader programs, for example, in a GPU. A pixel intensity distribution histogram (“histogram”) is a representation of the frequency of occurrence of distinctive pixel intensities within an image.

A fragment shader program (“shader”) is typically used to render a graphical image by calculating the desired color of a graphical object, however, exemplary embodiments of the present invention perform histogram calculations using a shader, for example, within a GPU. Accordingly, the impressive computational abilities of modern GPUs may be used for tasks other than graphical display.

### Image Segmentation

Image segmentation is a process by which a digital image, for example, a medical image, may be analyzed to determine what portion of the image belongs to a region of interest and what portion of the image is beyond the region of interest. For example, if an image is an MRI scan of a human brain, image segmentation may be performed to isolate the volume of a tumor within the brain. Segmentation may utilize an image histogram representing the distribution of pixel intensities within the image to determine the bounds of the region of interest. Image segmentation may be an iterative process by which a first-order approximation is identified and this first-order approximation is used to generate a more refined second-order approximation, etc. At each iteration, refinement may include a judgment as to whether borderline pixels should be added to or removed from the region of interest.

Segmentation may be represented by a phi value, where each pixel of the image that has been determined to be part of an object of interest has a phi value greater or equal to zero and each pixel of the image that has been determined not to be part of the object of interest has a phi value that is less than zero.

### Computing Histograms Using GPU

An image histogram may be computed by sequentially analyzing each pixel of an image. The full range of possible pixel intensities may be divided into bins. For example, if a pixel can have an intensity value between 0 and 15, a first bin may be from 0 to 3, a second bin may be from 4 to 7, a third bin may be from 8 to 11 and a fourth bin may be from 12 to 15. Each bin may have an associated counter and each counter may begin as zero. As each pixel is analyzed, it is determined to which bin that pixel belongs. The corresponding counter may then be advanced by one and the next pixel may be analyzed. After all pixels have been analyzed, the set of bins represents the image histogram and tells us the distribution of pixel intensities within the full image. Any number of bins may be used. The number of bins used represents the histogram granularity. The more bins are used, the finer the granularity and the more intensive the calculations become.

Thus, the computation of an image histogram uses two memory locations x and y, where x is the address of the pixel in memory and y is the counter address. Accordingly, when an image histogram is computed using a CPU, the following steps are executed:

1. Retrieve image pixel at memory address x

2. Determine which counter to increment based on the value found at address x

3. Read appropriate counter from address y

4. Increment counter found at address y

5. Write back incremented counter to address y

Accordingly, data is processed from address x while the resulting data is saved as a change to address y. While this process is not difficult for a CPU, a GPU is generally limited to writing back data to the same address where the data to be processed was read from. Thus, to accommodate the use of the GPU, the counters y may be processed and while each counter is being processed, each pixel may be looped through.

In practice, this approach may begin with the first counter and then analyze each image pixel to determine its baring on the first counter. Then, the next counter may be considered and each image pixel may be analyzed again. Accordingly, each pixel is analyzed once for each counter. So, when the granularity has 4 bins, each pixel of the image must be analyzed 4 times.

Moreover, the issue of repetitive pixel analysis is exacerbated by limitations in GPU texture memory bandwidth. Fetching each pixel multiple times from texture memory is relatively time consuming. Accordingly, use of the GPU to calculate the image histogram can be quite time consuming, especially as the granularity increases.

### Image Subdivision

Exemplary embodiments of the present invention seek to process an image histogram using a GPU in an efficient manner. Accordingly, rather than calculating the global image histogram at once, the image domain may be divided into evenly sized tiles. Then for each tile, the tile histogram may be calculated by analyzing each pixel of the tile for each bin. The bin totals for a particular tile may be stored in tile-specific counters. Accordingly, the computation of the tile histogram for each tile is independent of the computation of the remaining tile histograms for the remaining tiles. Multiple tile histograms may then be calculated in parallel, using the highly-parallel architecture of the modern GPU. After all of the tile histograms have been calculated, they may all be combined to provide the global image histogram.

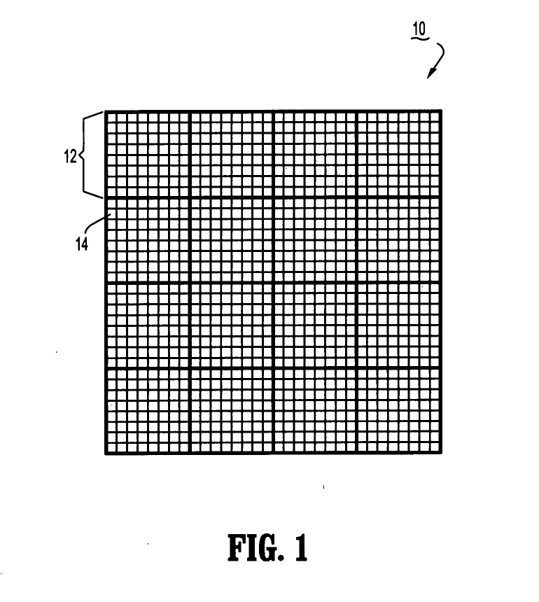

FIG. 1 illustrates image subdivision according to an exemplary embodiment of the present invention. The complete field of the image, known as the image domain 10, may be stored in GPU memory as a texture. This texture may be called an image texture as it represents the entire image. The domain 10 may be divided into an i×i matrix of tiles 12. In FIG. 1, i is shown to be 4 for ease of illustration and thus, the domain 10 is shown to be divided into 16 tiles 12. The image is a digital image and is thus comprised of pixels. When transferred to the texture memory of the GPU, each pixel is represented as a texture element (“texel”) 14. Each tile 12 may include an m×m matrix of texels 14. In FIG. 1, m is shown to be 8 for ease of illustration and thus, each tile 12 is shown to include 64 texels 14. The entire domain 10 thus includes an n×n matrix of texels 14. In FIG. 1, n is shown to be 32 for ease of illustration. Accordingly, i=n/m (here, 4=32/8).

After the image has been subdivided into tiles 12, local tile histograms may be computed in parallel as discussed above.

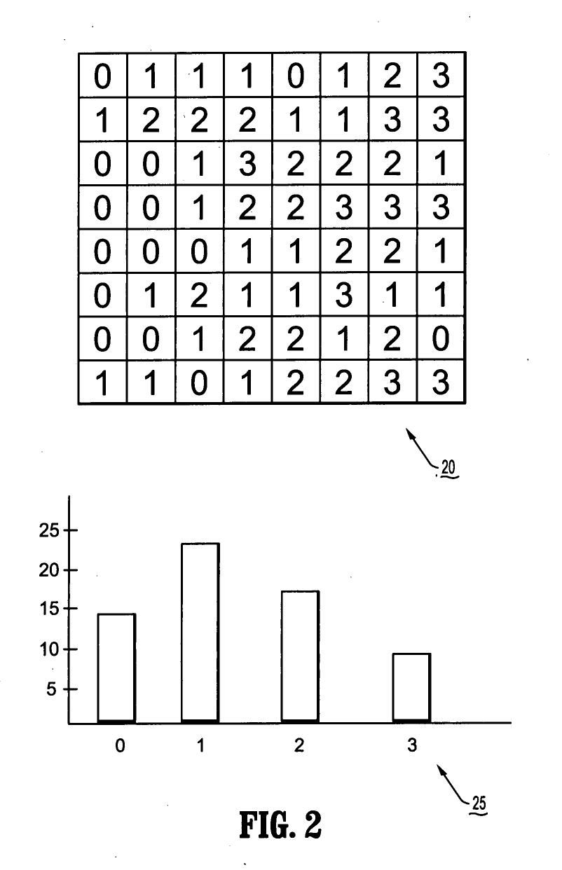

FIG. 2 illustrates an example tile and a corresponding example tile histogram according to an exemplary embodiment of the present invention. The example tile 20 includes texels of various intensities. For ease of illustration, each texel is given an intensity of 0, 1, 2, or 3. The occurrence of each texel intensity is counted and illustrated in the example histogram 25.

After one local histogram is calculated for each tile, the calculated tile histograms may be stored as an output texture which resides in GPU texture memory. The local histograms may then be summed up to determine the global image histogram.

### Tile Exclusion

The introduction of image subdivision presents the opportunity to pick and choose which tiles of the image need to be analyzed rather than analyzing the entire image. As discussed above, even though the GPU is able to calculate multiple tile histograms in parallel, the limited bandwidth of the texture memory makes the calculation of each tile histogram relatively time consuming. Exemplary embodiments of the present invention seek to reduce the time needed to calculate the global image histogram by allowing for the inclusion and/or exclusion of particular tiles from counting such that a tile histogram is calculated for included tiles but no tile histogram is calculated for excluded tiles. By preventing the calculating of tile histograms for excluded tiles, the number of costly texture fetches may be substantially reduced and the length of time required for calculating the global image histogram may be similarly reduced.

A histogram tile map may be used to identify which tiles are included and which tiles are excluded. The tile map may be located in the GPU texture memory as a texture. The tile map texture may consist of i×i texels, with each texel representing a tile of the image texture. Each texel may have a value of either 0 or 1, where 0 may represent an excluded tile and 1 may represent an included tile. Thus, when the GPU is engaged in calculating tile histograms, the tile map may be read and processing may be skipped where the tile map indicates that a tile is excluded.

The tile map may be generated by a simplified analysis of the input texture through a reduce operation [In the Westerman-paper which is about linear algebra operators it is called “vector reduce”. In general it is rather called “texture reduce” or simply “reduce”].

The input texture represents the current state of an ongoing segmentation. The segmentation is represented according to the segmentation method used. For example, the Level Set method of segmentation may be used. Here, a value of a function phi is used for every pixel of the image. Thus, the input texture for generating the tile map is a texture that contains phi and may be the same size as the image texture.

In this operation, multiple rendering passes recursively combine texels of the input texture to produce a simplified profile of the input. In texture reduce, the reduce operation combines the texture entries in multiple rendering passes by recursively combining the result of the previous pass. Starting with the original 2-dimentional matrix of texels, multiple passes may be performed until the texels are reduced to a tile map where tiles beyond the region of interest are indicated with a value of zero while tiles that include the region of interest may be indicated with a value of greater than zero. Additional explanation of reduce operations may be found in Krüger, J. and Westermann, R. 2003, Linear Algebra Operators for GPU Implementation of Numerical Algorithms, ACM Transactions on Graphics (TOG) 22, 3, 908-916, which is hereby incorporated by reference.

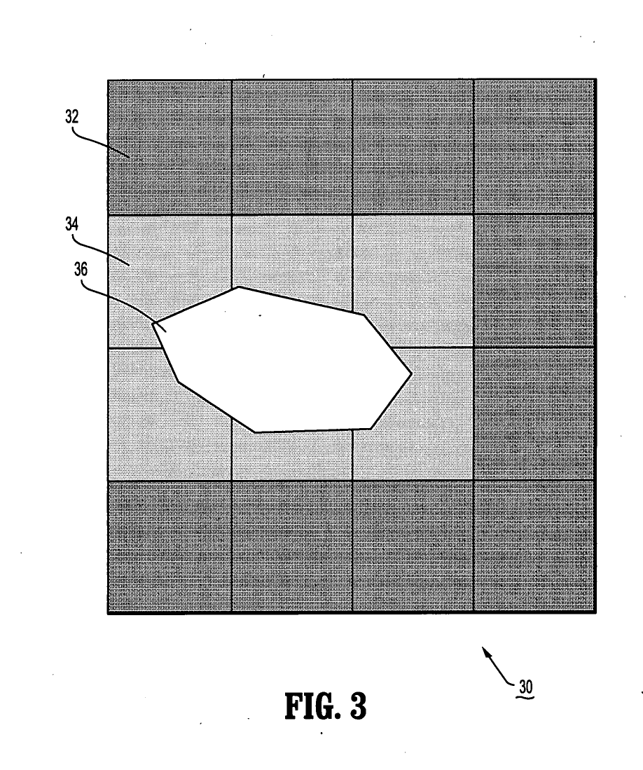

FIG. 3 illustrates an example of included and excluded tiles in a subdivided image domain according to an exemplary embodiment of the present invention. The image domain 30 is shown as being divided into 16 tiles of equal size. An object of interest 36 is located within several of the tiles. Exemplary embodiments of the present invention include tiles that have at least a portion of the object of interest 36 and exclude the tiles that do not. In this figure, the light tiles 34 represent the included tiles and the dark tiles 32 represent the excluded tiles. When local tile histograms are calculated, tile histograms are only calculated for those tiles that are included.

### Iterative Improvements

Image segmentation need not be a static process and segmentation results may be improved upon through subsequent iterations. For example, previously acquired image segmentation may be used to generate an enhanced segmentation. While the segmentation boundary moves with every iteration, different regions of the input image may become part (or not part) of the segmented region(s). Thus, different histogram tiles may be enabled or disabled, indicated by the tile map which is updated constantly.

Accordingly, image segmentation may be calculated, analyzed and refined until the boundaries of the object of interest have been clearly defined, for example, iterative improvements may persist until subsequent iterations no longer provide substantial change. Other modalities of iterative improvement may be applied, and the example above is shown merely for illustrative purposes.

For example, a first-order approximation for image segmentation may be provided by a user, for example, a medical practitioner. This first-order approximation may be used to initially develop the tile map. The tile map may be used to exclude tiles from calculation so that in the next refinement of image segmentation, local histograms do not need to be calculated for all tiles.

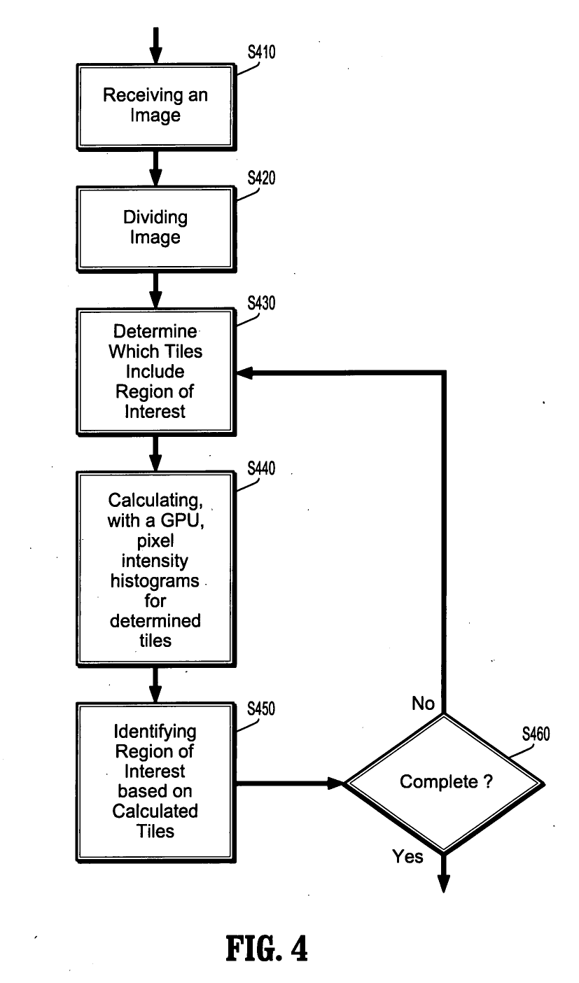

FIG. 4 is a flow chart illustrating a method for identifying a region of interest within an image according to an exemplary embodiment of the present invention. Iterative improvement is shown in this figure, although iteration is an optional feature of the present invention.

First, an image may be received (Step S410). The image may be divided into tiles (Step S420). It may then be determined which tiles include the region of interest and which tiles do not include the region of interest (Step S430). This determination may be preliminarily made according to user input, but may be subsequently refined in later iterations without the need for user input. A GPU may then be used to calculate pixel intensity histograms for each tile determined to include the region of interest while pixel intensity histograms are not calculated for the tiles determined to not include the region of interest (Step S440). Then, the region of interest may be identified (Step S450). Identification may be performed, for example, using a segmentation technique known to those skilled in the art. The segmentation technique may use the calculated pixel intensity histograms. After the region of interest has been identified (Step S450), the steps of determining which tiles are included in the region of interest (Step S430), calculating pixel intensity histograms for the determined tiles (Step S440), and identifying the region of interest (Step S450) may be iteratively refined. Iterative refinement may be complete (Step S460), for example, when subsequent iterations provide little to no refinement. However, as long as iterative refinement is not complete (No, Step S460), the process will repeat at Step S430.

### Clinical Application

Exemplary embodiments of the present invention may be implemented using a computer system that acquires a digital image. FIG. 4 shows an exemplary computer system capable of performing exemplary embodiments of the present invention. With respect to FIG. 4, the computer system 1000 includes a CPU 1001 connected to a central data bus 1002. Memory, for example, main random access memory (RAM) 1002 may be connected to the data bus 1002. A hard disk 1003 may be connected to the data bus 1002, for example, over an advanced technology attachment (ATA) adapter 1004, such as an IDE adapter or a Serial ATA adapter. One or more input devices 1007, for example, a keyboard and mouse, may be connected to the data bus 1002, for example, over a universal serial bus (USB) or PS/2 port adapter (not shown). A GPU 1008, for example, incorporated into a graphics card, may be connected to the data bus 1002, for example, over a PCI, AGP, or PCIe adapter (not shown). A display device 1007, for example, a computer monitor, may be connected to the computer 1000 through the graphics card including the GPU 1008. A network adapter 1006, for example, a LAN adapter, may be connected to the data bus 1002. The network adapter 1006 may be connected to a network 1010, for example a local area network (LAN) such as an intranet and/or a wide area network (WAN) such as the Internet.

The computer 1000 may receive digital images from an image acquisition system 1011, for example, over the network 1010. The image acquisition system 1011 may be, for example, a medical image database system or a medical imaging device.

A user, for example, a radiologist or technician, may interact with the computer through the input devices 1007 to initiate the processing of an image, for example, an image received from the image acquisition system 1011. The image may be processed by the GPU 1008, for example, as described above. Processing of the image may include image segmentation, for example, to identify a region of interest. The identified region of interest may then be indicated on the original medical image. Image processing results may then be displayed through the display device 1009, printed through a printer connected over a interface 1005 or the network 1010, and/or sent to the medical image database system for later retrieval. A medical practitioner, for example, a radiologist, may then examine the medical image and may be made aware of the identified region of interest to assist in diagnosis.

The above specific exemplary embodiments are illustrative, and many variations can be introduced on these embodiments without departing from the spirit of the disclosure or from the scope of the appended claims. For example, elements and/or features of different exemplary embodiments may be combined with each other and/or substituted for each other within the scope of this disclosure and appended claims.

What is claimed is:

1. A method for identifying a region of interest within an image, comprising:
receiving an image;
dividing the image into a plurality of tiles;
determining which of the plurality of tiles include the region of interest;
calculating, within a graphics processing unit (GPU), a pixel intensity histogram for tiles that have been determined to include the region of interest and not calculating a pixel intensity histogram for tiles that do not include the region of interest; and
identifying the region of interest based on the calculated pixel intensity histograms.

2. The method of claim 1, wherein each of the plurality of tiles is an equally sized region of the image.

3. The method of claim 1, wherein determining which of the plurality of tiles includes the region of interest comprises performing a reduce operation.

4. The method of claim 3, wherein the reduce operation is performed one or more times upon the image or a processed version of the image.

5. The method of claim 1, wherein determining which of the plurality of tiles includes the region of interest is initially based on user input.

6. The method of claim 1, wherein two or more of the pixel intensity histograms for each tile are performed, in parallel, within the GPU.

7. The method of claim 1, wherein the received image is stored as a texture in the texture memory of the GPU.

8. The method of claim 1, wherein identifying the region of interest based on the calculated pixel intensity histograms comprises calculating a global image histogram based on the calculated pixel intensity histograms.

9. The method of claim 1, wherein identifying the region of interest based on the calculated pixel intensity histograms comprises:
receiving an initial segmentation based on a user input; and
iteratively improving the calculated region of interest.

10. The method of claim 9, wherein the iterative improvement comprises:
refining the determination as to which of the plurality of tiles includes the region of interest;
recalculating the pixel intensity histogram for each tile that has been determined to include the region of interest; and
identifying an improved region of interest based on the recalculated pixel intensity histograms.

11. The method of claim 1, further comprising locating the identified region of interest on the image.

12. A system for identifying a region of interest within an image, comprising:
a graphical processing unit (GPU) for storing the image in texture memory;
an image subdividing unit for dividing the image into a plurality of tiles of the same size;
a tile map for indicating which of the plurality of tiles are excluded from calculation; and
a tile histogram calculating unit for calculating tile histograms for each of the plurality of tiles that are not excluded from calculation and not calculating tile histograms for each of the plurality of tiles that are excluded from calculation.

13. The system of claim 12, further comprising an image acquisition system for providing the image to the GPU.

14. The system of claim 13, wherein the image acquisition system is a medical imaging device.

15. The system of claim 13, wherein the image acquisition system is a medical image database system.

16. A computer system comprising:
a processor; and
a program storage device readable by the computer system, embodying a program of instructions executable by the processor to perform method steps for calculating a global pixel intensity histogram, the method comprising:
dividing an image into a plurality of tiles;
generating a tile map for indicating which of the plurality of tiles are excluded from calculation;
calculating, within a graphics processing unit (GPU), a tile histogram for each of the plurality of tiles not excluded from calculation and not calculating a tile histogram for each of the plurality of tiles that are excluded from calculation; and
calculating a global pixel intensity histogram based on the calculated tile histograms.

17. The computer system of claim 16, wherein a region of interest is identified within the image using the tile histograms.

18. The computer system of claim 17, wherein identification of the region of interest using the tile histograms includes image segmentation.

19. The computer system of claim 18, wherein the tile map is generated using user input.

20. The computer system of claim 18, wherein the tile map is generated using a reduce operation.
